(19) United States
(12) Patent Application Publication
(10) Pub. No.: US 2021/0027332 A1
(43) Pub. Date: Jan. 28, 2021

(54) METHOD OF OPERATING SHORT-TERM RENTAL RESTAURANT AND PERSUADING USERS TO VISIT SHORT-TERM RENTAL RESTAURANT BASED ON PROFILE

(71) Applicant: JONG OH LEE, Bucheon-si (KR)

(72) Inventor: JONG OH LEE, Bucheon-si (KR)

(21) Appl. No.: 16/939,058

(22) Filed: Jul. 27, 2020

(30) Foreign Application Priority Data
Jul. 26, 2019 (KR) 10-2019-0090828

(51) Int. Cl. G06Q 30/02; G06Q 50/00; G06Q 30/06; G06Q 10/08; G06Q 50/18; G06F 16/23; G06F 16/29; H04L 29/06

(52) U.S. Cl. CPC G06Q 30/0256; G06Q 50/01; G06Q 30/0645; G06Q 10/0875; G06Q 30/0273; G06Q 30/0627; G06F 16/2379; G06F 16/29; H04L 63/102; G06Q 50/18

(57) ABSTRACT

A method of operating a short-term rental restaurant and persuading users to visit the short-term rental restaurant on the basis of a profile, includes: creating by, a central server, a profile channel, the central server being configured to broker a lease of a shared restaurant for a predetermined short period of time; registering, by the central server, information about favorable users; registering rental information with the central server by a shared-restaurant manager terminal used by a shared-restaurant manager operating the shared restaurant equipped with the kitchen utensils; signing, by a profile manager terminal used by the profile manager, a contract to rent a short-term rental restaurant by retrieving shared restaurants registered with the central server to select one shared restaurant as the short-term rental restaurant; and providing, by the central server, sales information of the shared restaurant of the profile manager to a terminal of a favorable user.

### TECHNICAL FIELD

The present disclosure relates to a method of operating a restaurant and persuading users to visit the restaurant, and more particularly, to a method of operating a short-term rental restaurant and persuading users to visit the short-term rental restaurant on the basis of a profile.

### BACKGROUND ART

Recently, as one of the Internet services for those who want to start up businesses, various start-up support sites are rapidly increasing to introduce franchises and provide information related to starting up businesses.

The Korean National Tax Service has reported that enormous social costs are evaporating as more than 800,000 small business owners closed their business each year. Currently, small business support policies are mostly limited to start-ups themselves and thus social anxiety factors such as the senses of loss, alienation, frustration, etc. experienced by small business owners due to the closure of businesses are not properly dealt with.

There is an urgent need to develop a system for improving a saturated and overcrowded state of small businesses in a situation in which a virtuous-cycle ecosystem of a small business lifecycle consisting of start-up, growth, maturity, and closure is not properly established.

In particular, when a restaurant is to be operated for a short period of time, e.g., less than a month, it is inconvenient to find a suitable business place due to an existing rental contracting system that requires monthly rental fees and it is impossible to continuously persuade customers due to limitations of pop-up stores even when a business place is found and the restaurant is started.

Therefore, there is an urgent need for a means to easily find a business place that is convenient to rent for a short period of time through mediation between a restaurant lessor and a business that desires to rent the restaurant and to persuade existing customers to visit a new business place or the same place even when the business place is rented again for a short period of time after a short-term rental business is over.

### PRIOR ART LITERATURE

### [Patent Document]

(Patent Document 0001) Korean Patent Publication No. 10-2012-0100174

### DISCLOSURE

### Technical Problem

The present disclosure is directed to providing an application service suitable for use in smart terminals and designed to induce continuous visits of customers through organic combination with an Online-To-Offline (O2O) service and help commercialize private restaurants through a ‘profile’-based franchise so as to solve a problem that doing business through a method of persuading customers (securing regular customers), which is employed in the existing food service industry, is limited when introducing a shared economy system called a ‘shared restaurant’ to reduce food service start-up risks.

### Technical Solution

An aspect of the present disclosure includes a method of operating a short-term rental restaurant and persuading users to visit the short-term rental restaurant on the basis of a profile, the method including creating by, a central server, a profile channel including a ‘like’ button for each profile manager who wants to rent and open a restaurant for a predetermined short period of time, the central server being configured to broker a lease of a shared restaurant for a predetermined short period of time; registering, by the central server, information about favorable users by storing information about users who clicked the like button for each profile channel; registering rental information, including a location of a shared restaurant, a rental period, the type of kitchen utensils, a rental fee, items to be supplied, pictures, the number of tables, and the number of chairs, with the central server by a shared-restaurant manager terminal used by a shared-restaurant manager operating the shared restaurant equipped with the kitchen utensils; signing, by a profile manager terminal used by the profile manager, a contract to rent a short-term rental restaurant by retrieving shared restaurants registered with the central server to select one shared restaurant as the short-term rental restaurant and providing, by the central server, sales information of the shared restaurant of the profile manager to a terminal of a favorable user who clicked the ‘like’ button in a profile channel operated by the profile manager who has signed the contract to rent the short-term rental restaurant.

The profile channel may include a map display field displaying a map, wherein only the map may be displayed on the map display field while no restaurant is operated by the profile manager, and sales information including a location of the restaurant operated by the profile manager and a business period may be additionally displayed on the map display field while the restaurant is operated by the profile manager after completion of a contract to rent a short-term rental restaurant.

The profile channel may include a franchise button for applying for a franchise operated by the profile manager, wherein a user may be able to contact the profile manager through the franchise button and obtain profile manager authority of the franchise when permitted.

The registering of the information about favorable users may include providing a regional distribution of users who clicked the ‘like’ button for each profile channel to each profile manager terminal.

The registering of the information about favorable users may include calculating the amount of increase of the number of likes that a business renting each shared restaurant received for a rental period and providing a terminal of the profile manager with information about the amount of change in the number of likes received by a specific shared restaurant for the rental period.

The method may further include providing retrieved information to a terminal of a user by searching for profile channels of restaurants operated at a search location and a visit date that are input by the user.

The method may further include recommending similar profiles and sharing experiences of eating out by providing the terminal of the user with information about a profile channel for which a like is clicked by a person registered as a friend of the user and a photo review created by the friend.

### Advantageous Effects

According to an embodiment of the present disclosure, a shared-restaurant Online-To-Offline (O2O) revisiting induction application that organically combines a shared economic element and an O2O service is implemented to induce ‘continuous’ visits of customers for a lessee business owner despite of ‘limited’ pop-up store business and help commercialization of private restaurants in the Korean society where a ratio of long-term sales is high, thereby increasing an employment rate.

According to an embodiment of the present disclosure, a profile manager (main store) may increase the number of ‘likes’ in a profile together with a manager of a franchise to increase store awareness and thus the visit of visitors through pop-up sales using a channel created by the main store can be expected in terms of the franchise. Therefore, it can be expected to increase an employment rate by helping commercialization of private restaurants in the Korean society where a proportion of individual business owners is high.

In addition, according to an embodiment of the present disclosure, it is possible to prevent creation of profiles of Food and Beverage (F&B) businesses having similar concepts and help commercialization of existing businesses through rapid expansion, thereby achieving an effect of relieving competition.

### DESCRIPTION OF DRAWINGS

FIG. 1 is a conceptual diagram illustrating implementation of a platform for operating a short-term rental restaurant and persuading users to visit the short-term rental restaurant on the basis of a profile according to an embodiment of the present disclosure.

FIG. 2 is a configuration diagram of a system for the platform for operating a short-term rental restaurant and persuading users to visit the short-term rental restaurant on the basis of a profile according to an embodiment of the present disclosure.

FIG. 3 is a block diagram of a central server according to an embodiment of the present disclosure.

FIG. 4 is a flowchart of a method of operating a short-term rental restaurant and persuading users to visit the short-term rental restaurant on the basis of a profile according to an embodiment of the present disclosure.

FIG. 5 illustrates an example of a profile channel according to an embodiment of the present disclosure.

FIG. 6 illustrates an example of a profile channel displaying only a map according to an embodiment of the present disclosure.

FIG. 7 illustrates an example of a profile channel in which sales information is shown on a map according to an embodiment of the present disclosure.

FIG. 8 is a diagram illustrating the visit of various customer groups through obtaining profile manager authority of a franchise according to an embodiment of the present disclosure.

FIG. 9 is a diagram illustrating an example of registering a short-term rental restaurant and signing a contract to rent the short-term rental restaurant according to an embodiment of the present disclosure.

FIG. 10 is a diagram illustrating the provision of information about profile channels of restaurants operating at a location and a visit date which are input by a user according to an embodiment of the present disclosure.

### MODES OF THE INVENTION

Advantages and features of the present disclosure and methods of achieving them will be apparent from embodiments described below in conjunction with the accompanying drawings. However, the present disclosure is not limited to the embodiments set forth herein and may be embodied in many different forms and these embodiments are provided so that this disclosure will be thorough and complete and will fully convey the concept of the present disclosure to those of ordinary skill in the art. Therefore, the present disclosure should be defined by the scope of the appended claims. In the following description of the present disclosure, well-known technologies and the like are not described in detail when it is determined that they would obscure the present disclosure due to unnecessary detail.

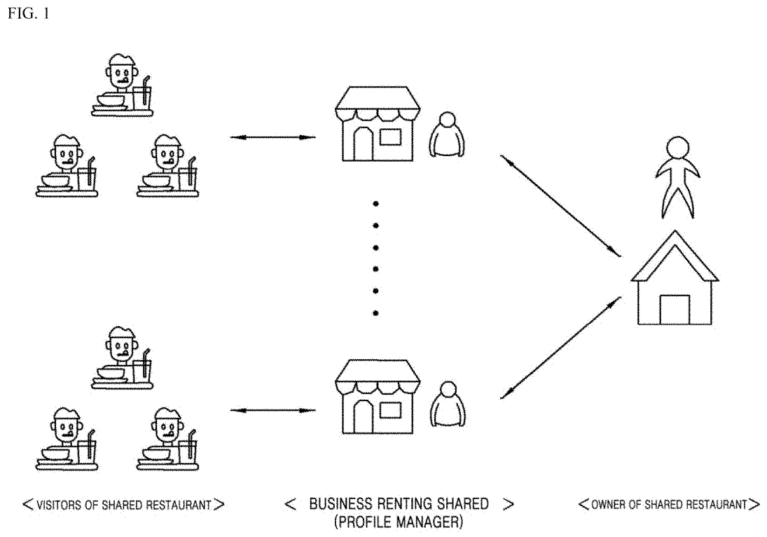

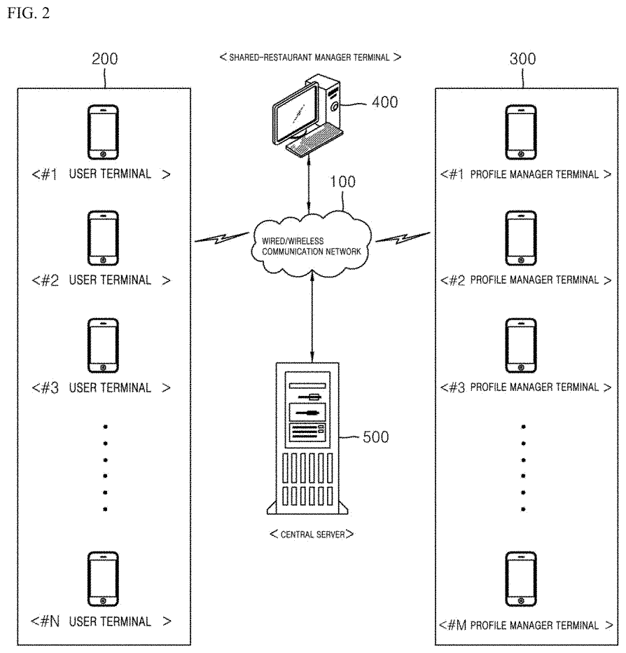

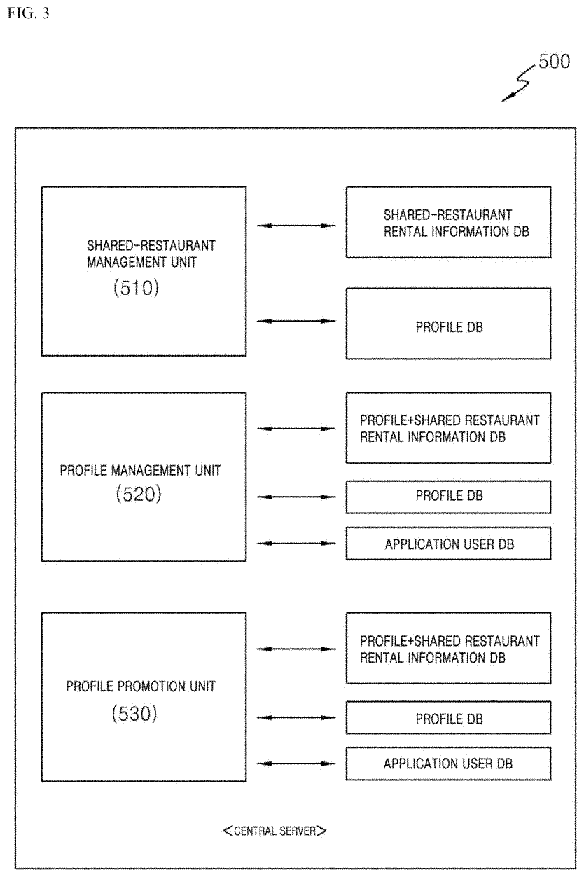

FIG. 1 is a conceptual diagram illustrating implementation of a platform for operating a short-term rental restaurant and persuading users to visit the short-term rental restaurant on the basis of a profile according to an embodiment of the present disclosure. FIG. 2 is a configuration diagram of a system for the platform for operating a short-term rental restaurant and persuading users to visit the short-term rental restaurant on the basis of a profile according to an embodiment of the present disclosure. FIG. 3 is a block diagram of a central server according to an embodiment of the present disclosure.

As illustrated in FIG. 1, according to the present disclosure, a business place may be conveniently rented through mediation between a lessor who wants to rent a restaurant to someone else for a short period of time (less than a month) and a business that desires to rent the restaurant so as to compensate for a problem that it is inconvenient to find a business place for operating a restaurant for a short period of time (e.g., less than a month) due to an existing rental contract method that requires monthly rental fees and it is impossible to continuously persuade customers due to limitations of a pop-up store even when a business place is found to do business. In addition, the present disclosure suggests a new ‘profile’-based Online-To-Offline (O2O) platform whereby a business that desires to rent a restaurant may create a new channel, i.e., ‘profile’, through an application to persuade visitors to click a ‘like’ button 10 on the profile after installation of the application in smart terminals of the visitors during a short-term operation of the restaurant, so that sales information may be automatically transmitted to the visitors who clicked the ‘like’ button 10 via this channel when the restaurant is reopened, thereby inducing offline visits.

To this end, the system for the platform for operating a short-term rental restaurant and persuading visitors on the basis of a profile of the present disclosure may include a wired/wireless communication network 100, a user terminal 200, a shared-restaurant manager terminal 400, a profile manager terminal 300, and a central server 500 as illustrated in FIG. 2.

The wired/wireless communication network 100 is a communication network via which wired or wireless communication is established among the user terminal 200, the shared-restaurant manager terminal 400, the profile manager terminal 300, and the central server 500. When the wired/wireless communication network 100 is embodied as a wireless communication network, data communication may be established using a wireless mobile communication network including a base transceiver station (BTS), a mobile switching center (MSC), and a home location register (HLR). When the wired/wireless communication network 100 is embodied as a wired communication network, data communication may be established according to an Internet protocol such as Transmission Control Protocol/Internet Protocol (TCP/IP).

The user terminal 200 is a terminal used by a customer who wants to visit a restaurant and is illustrated as a smart phone in FIG. 2 but may include various communication terminals such as a tablet personal computer (PC), a desktop PC, and a laptop computer, as well as the smart phone. The user terminal 200 refers to a terminal used by a customer to access a profile channel operated by a profile manager to view information about the business operated by the profile manager.

By accessing the central server 500 with the user terminal 200 via the wired/wireless communication network 100, personal identification information (name, date of birth, phone number, sex, password, email account, identification (ID), location information, etc.) may be input to register as a member so as to access each profile channel.

The shared-restaurant manager terminal 400 refers to a terminal used by a shared-restaurant manager who operates a shared restaurant, which is a rental restaurant equipped with kitchen utensils and may also include a desktop PC, a smart phone, a laptop computer, and the like. Here, the “shared restaurant” refers to a restaurant that is equipped with various cooking utensils to change the atmosphere of the restaurant according to a business that rents the shared restaurant and has features of a random restaurant in which a menu can be frequently changed according to visitors. A concept of the shared restaurant may be changed according to a business that rents the shared restaurant for a short period of time.

Through the shared-restaurant manager terminal 400, rental information, including the location of a shared restaurant, a rental period, the type of kitchen utensils, the rental price, items to be supplied, pictures, the number of tables, and the number of chairs, may be registered with the central server 500 to request rental mediation.

The profile manager terminal 300 refers to a terminal used by a person who wants to rent a shared restaurant for a short period of time (less than a month) to operate a restaurant and may also include a desktop PC, a smart phone, a laptop computer, and the like. The profile manager manages and operates his/her profile channel allocated and provided by the central server 500. The profile manager searches for shared restaurants registered in the central server 500 to select one shared restaurant as a short-term rental restaurant and sign a contract to rent the selected shared restaurant.

For reference, a profile manager refers to a person who intends to rent a shared restaurant for a short period of time (e.g., less than a month) to open a restaurant. Therefore, the profile channel is an online content channel assigned to each profile manager and is provided with business information (business name, the type of business, a menu, members of the business) operated by the profile manager, a button to receive likes from customers, the number of likes, photo reviews, sales information, etc.

The central server 500 performs a function of brokering a lease for a shared restaurant for a predetermined short period of time, and may have the same configuration as a general web server in terms of hardware and include a program module, which is implemented in various languages such as C, C++, Java, Visual Basic and Visual C to perform various functions, in terms of software. Alternatively, the central server 500 may be implemented in general server hardware using web server programs provided in various ways according to operating systems such as DOS, Windows, Linux, Unix, and Macintosh.

As illustrated in FIG. 3, the central server 500 includes a shared-restaurant management unit 510, a profile management unit 520, and a profile promotion unit 530. The shared-restaurant management unit 510 manages a rental information database (DB) of shared restaurants and manages profiles. The profile management unit 520 manages a rental information DB of profiles and shared restaurants and manages the profiles and user information. The profile promotion unit 530 promotes a profile and also manages not only the rental information DB of profiles and shared restaurants but also profiles and user information.

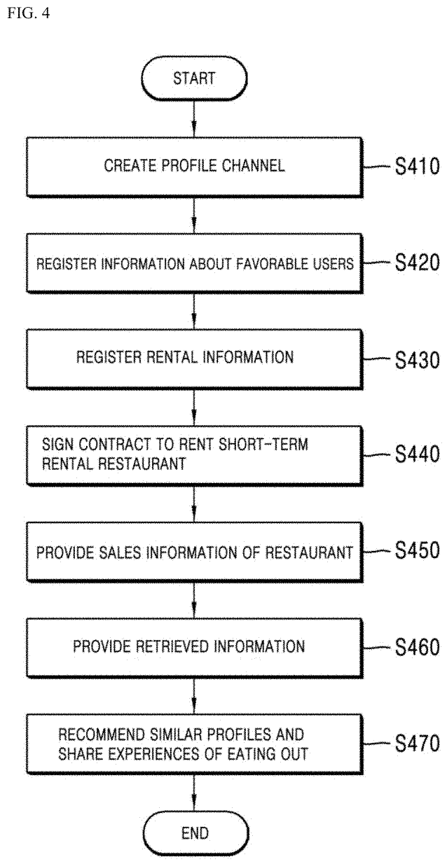

The central server 500 which includes the shared-restaurant management unit 510, the profile management unit 520, and the profile promotion unit 530 creates a profile channel including the ‘like’ button 10 for each profile manager who wants to rent and open a restaurant for a predetermined short period of time. In addition, the central server 500 stores information about users who clicked the ‘like’ button 10 for each profile channel and provides sales information of a restaurant of a profile manager who has signed a contract to rent a short-term rental restaurant to user terminals 200 of favorable users who clicked the ‘like’ button 10 on a profile channel operated by the profile manager. A broker operating the central server 500 may generate revenue through brokerage fees and profile advertising revenue. FIGS. 4 to 10 will be described together below.

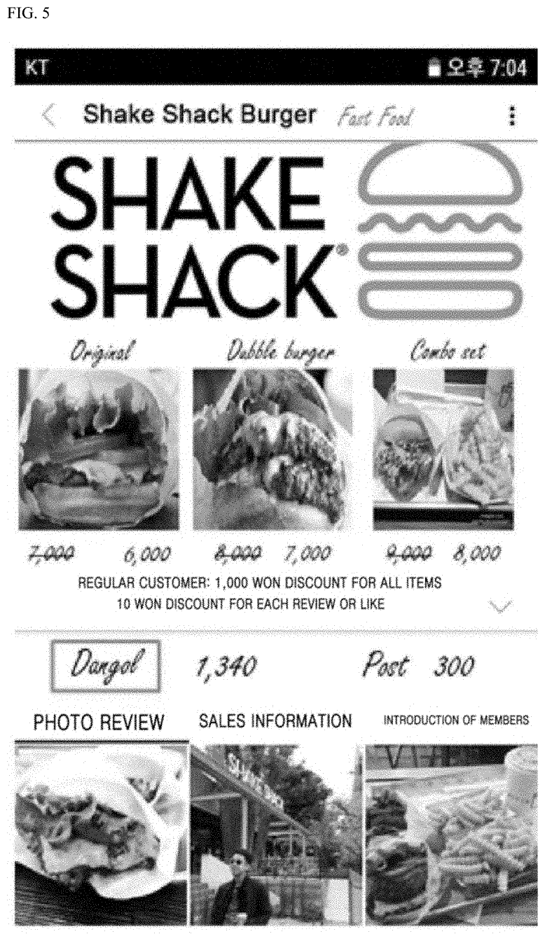

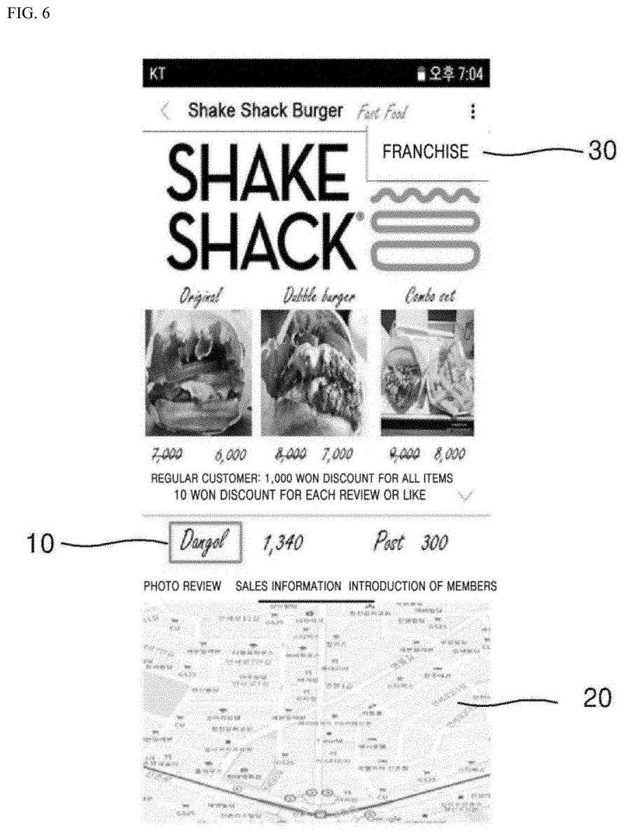

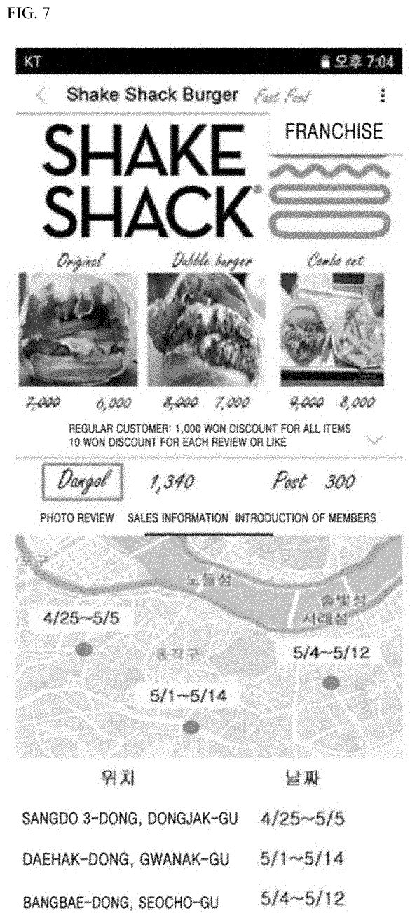

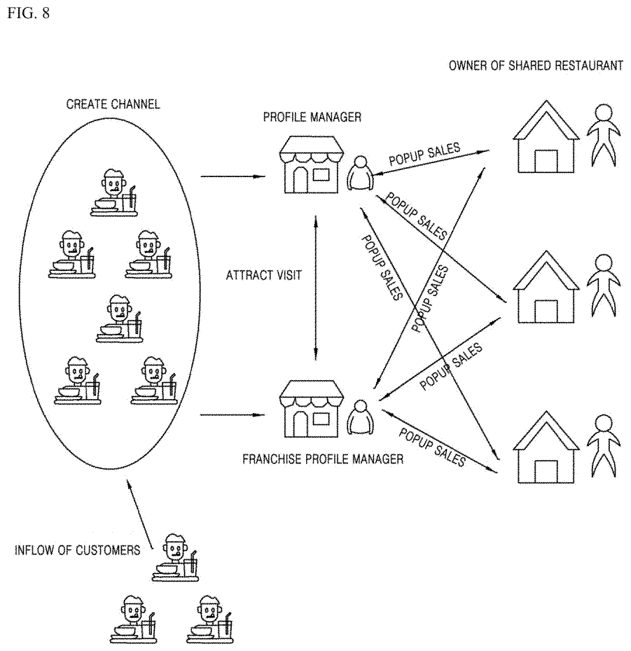

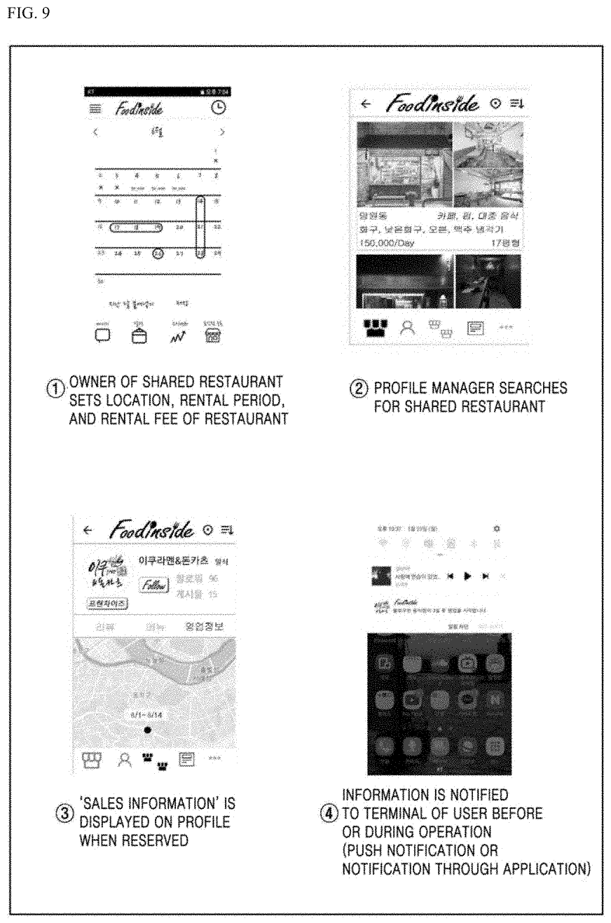

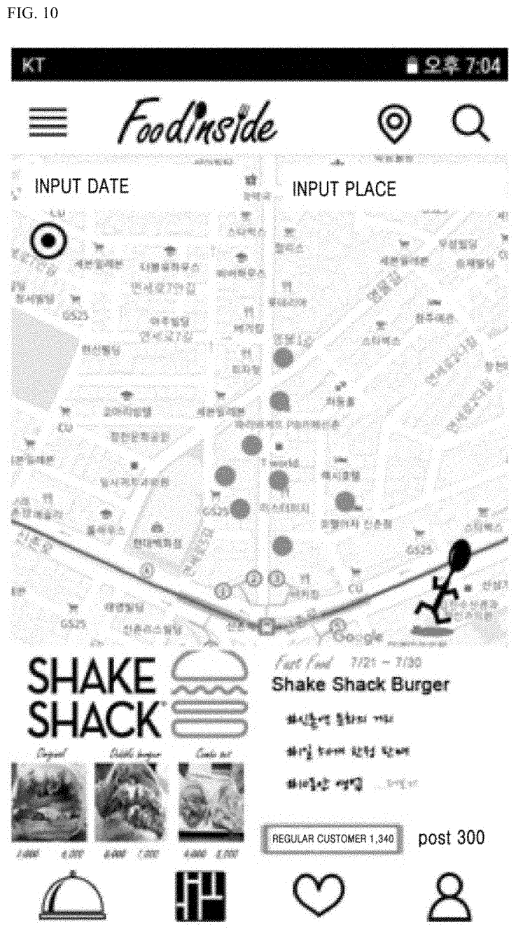

FIG. 4 is a flowchart of a method of operating a short-term rental restaurant and persuading users to visit the short-term rental restaurant on the basis of a profile according to an embodiment of the present disclosure. FIG. 5 illustrates an example of a profile channel according to an embodiment of the present disclosure. FIG. 6 illustrates an example of a profile channel displaying only a map according to an embodiment of the present disclosure. FIG. 7 illustrates an example of a profile channel in which sales information is shown on a map according to an embodiment of the present disclosure. FIG. 8 is a diagram illustrating the influx of an existing-channel customer group and a new customer group through obtaining profile manager authority of a franchise according to an embodiment of the present disclosure. FIG. 9 is a diagram illustrating an example in which a short-term rental restaurant is registered and contract is made therefor according to an embodiment of the present disclosure. FIG. 10 is a diagram illustrating providing information about profile channels of restaurants operating at a search location and a visit date which are input by a user according to an embodiment of the present disclosure.

As illustrated in FIG. 4, the method of operating a short-term rental restaurant and persuading users to visit the short-term rental restaurant on the basis of a profile according to the present disclosure may include creating, by the central server 500, a profile channel including the ‘like’ button 10 for each profile manager who wants to rent and open a restaurant for a predetermined short period of time (S410), registering by, the central server 500, information about favorable users by storing information about users who clicked the ‘like’ button 10 for each profile channel (S420), registering by, the shared-restaurant manager terminal 400, rental information, including the location of a shared restaurant, a rental period, the type of kitchen utensils, a rental fee, items to be supplied, pictures, the number of tables, and the number of chairs, with the central server 500 (S430), signing, by the profile manager terminal 300, a contract to rent a short-term rental restaurant by retrieving shared restaurants registered with the central server 500 to select one shared restaurant as the short-term rental restaurant (S440), and providing, by the central server 500, the user terminal 200 of a user who clicked the ‘like’ button 10 in a profile channel operated by a profile manager who has signed the contract to rent the short-term rental restaurant with sales information of the shared restaurant of the profile manager (S450). In addition, the method may further include providing retrieved information (S460) and recommending similar profiles and sharing experiences of eating out (S470). The above operations of the method will be described in detail below.

The creating of the profile channel (S410) includes creating and registering, by the central server 500, which brokers a lease of a shared restaurant for a predetermined short period of time, a profile channel including the ‘like’ button 10 for each profile manager who wants to rent and open a shared restaurant for a predetermined short period of time. When a profile application is executed in a terminal, the ‘like’ button 10 through which likes are received from users, a map display field 20 displaying a map, and a ‘franchise’ button 30 to apply for a franchise operated by a profile manager are displayed as illustrated in FIG. 6. For reference, a user may obtain profile manager authority by inputting details, e.g., a desired sales area, the type of a business, the name and pictures of the business, a description of a menu, members of the business, careers, etc. In some cases, the profile manager authority may be obtained without inputting details, e.g., a desired sales area, the type of a business, the name and pictures of the business, a description of a menu, members of the business, careers, etc.

The ‘like’ button 10 is a button that is pressed when users have a good feeling about the corresponding profile channel.

In the map display field 20, only a map is displayed while the restaurant of the corresponding profile manager is not operated as illustrated in FIG. 6, whereas while the profile manager has signed a contract to rent a short-term rental restaurant and is operating the restaurant, sales information, including the location of the restaurant, a sales period, and a menu of the restaurant operated by the profile manager is displayed as illustrated in FIG. 7. Therefore, users accessing the profile channel are able to notice the sales information of the restaurant that is being operated from the profile channel.

The ‘franchise’ button 30 is a button for a user to apply for a franchise operated by the profile manager. Accordingly, a user who clicks the ‘franchise’ button 30 may obtain profile manager authority of a franchise. The user is able to contact the profile manager through the ‘franchise’ button 30, is added as a ‘business member’ of the franchise, obtains profile manager authority of the franchise and is allowed to rent a shared restaurant when a franchise is given to the user.

As illustrated in FIG. 8, when a profile manager acquires profile manager authority of a franchise, various customer groups may be attracted. Therefore, facility investment costs of tens of millions of won were incurred in the past because facilities that meet guidelines should be provided for franchises but a profile franchise of the present disclosure is rapidly expandable by putting down deposits, signing a loyalty contract or the like without facility investment costs. The profile manager (main store) may increase the number of ‘likes’ on the profile together with a franchise profile manager (franchise) to increase store awareness and the franchise profile manager (franchise) can expect an inflow of visitors through popup sales via a channel created by the profile manager (main store). Therefore, it is expected to prevent creation of profiles of F&B businesses having similar concepts and promote commercialization through rapid expansion of existing businesses, thereby easing competition and increasing an employment rate.

The registering of the information about the favorable users (S420) is a process of storing, by the central server 500, information of users who clicked the ‘like’ button 10 for each profile channel. For example, when a user A is interested in a first profile channel and thus clicks the ‘like’ button 10, information about the user A is additionally registered as information about a favorable user in the first profile channel.

Furthermore, in the registering of the information about the favorable users (S420), information about a regional distribution of users who clicked the ‘like’ button 10 for each profile channel may be provided to each profile manager terminal 300. For example, users who clicked the ‘like’ button 10 in the first profile channel may be displayed on a map in units of ‘dong’, for example, thirty people in Ikseon-dong, fifty people in Hak-dong, and one hundred and fifty 1 people in Samcheong-dong.

When a contract to rent a shared restaurant is completed, sales information is provided to user terminals 200 of all users who clicked the ‘like’ button 10 in a corresponding ‘profile channel’ before a set rental period (three days to one month). For example, the sales information is provided before or while the shared restaurant is open.

In addition, in the registering of the information about the favorable users (S420), the amount of increase in the number of users who clicked the ‘like’ button 10 in a profile of a business in which each shared restaurant is open may be calculated and information about a specific shared restaurant and the amount of increase may be provided to the profile manager terminal 300. For example, when the ‘like’ button 10 was clicked by an average of 100 users per day with respect to a business renting a shared restaurant A, information about the shared restaurant A as a popular shared restaurant may be provided to the profile manager terminal 300.

The registering of the rental information (S430) is a process of registering rental information, including the location of a shared restaurant, a rental period, the type of kitchen utensils, a rental fee, items to be supplied, pictures, the number of tables, and the number of chairs, with the central server 500 by the shared-restaurant manager terminal 400 used by a shared-restaurant manager who is operating the shared restaurant which is a rental restaurant equipped with kitchen utensils. For reference, a user should input information about a shared restaurant (the type and sizes of kitchen utensils, items to be supplied, the number of tables, the number of chairs, pictures of the inside/outside of the shared restaurant, and the location of the shared restaurant) to obtain manager authority of the shared restaurant.

The signing of the contract to rent a short-term rental restaurant (S440) includes, by the profile manager terminal 300 used by the profile manager, selecting one shared restaurant as a short-term rental restaurant and signing a contract to rent the selected shared restaurant by retrieving shared restaurants registered with the central server 500.

The providing of the sales information of the shared restaurant of the profile manager (S450) includes providing, by the central server 500, the sales information of the shared restaurant of the profile manager to the user terminal 200 of a favorable user who clicked the ‘like’ button 10 in a profile channel operated by the profile manager who has signed the contract to rent the short-term rental restaurant.

Therefore, as illustrated in FIG. 9, a manager of a profile channel searches for a shared restaurant when the location of a restaurant, a rental period, and a rental fee are registered, and sales information is displayed in the profile channel and a sales notification is transmitted to the user terminal 200 of a user who clicked the ‘like’ button 10 when a contract to rent the shared restaurant is completed.

The providing of the retrieved information (S460) includes searching for profile channels in which a restaurant is open at a search location and a visit date that are input by a user and providing the found profile channels to the user terminal 200. For example, as illustrated in FIG. 10, when a location and a date are input, location information of shared restaurants near the input location and profiles of shared restaurants rented at the input date are collected from profile+shared restaurant rental information and are exposed on a map. Also, a summary of a profile (business name, a menu, the number of users who clicked a ‘like’ button, number of photo reviews, company introduction, business days, etc.) of each business renting a restaurant is exposed on the map and a main profile is exposed when the summary of the profile is clicked.

The recommending of similar profiles and sharing experiences of eating out (S470) includes providing the user terminal 200 with a profile channel for which the ‘like’ button 10 is clicked by a person registered as a friend of the user and a photo review created by the friend. In addition, advertising revenue can be created through exposure of recommended profiles.

The embodiments set forth herein are selected and provided as the most preferable examples to help the understanding of those of ordinary skill in the art from among various practical embodiments but the technical spirit of the present disclosure is not limited to these embodiments and various changes and modifications may be made and other equivalent embodiments may be implemented without departing from the technical spirit of the present disclosure.

### REFERENCE NUMERALS

100: wired/wireless communication network
200: user terminal
300: profile manager terminal
400: shared-restaurant manager terminal
500: central server

1. A method of operating a short-term rental restaurant and persuading users to visit the short-term rental restaurant on the basis of a profile, the method comprising:
creating by, a central server, a profile channel including a like button for each profile manager who wants to rent and open a restaurant for a predetermined short period of time, the central server being configured to broker a lease of a shared restaurant for a predetermined short period of time;
registering, by the central server, information about favorable users by storing information about users who clicked the like button for each profile channel;
registering rental information, including a location of a shared restaurant, a rental period, the type of kitchen utensils, a rental fee, items to be supplied, pictures, the number of tables, and the number of chairs, with the central server by a shared-restaurant manager terminal used by a shared-restaurant manager operating the shared restaurant equipped with the kitchen utensils;
signing, by a profile manager terminal used by the profile manager, a contract to rent a short-term rental restaurant by retrieving shared restaurants registered with the central server to select one shared restaurant as the short-term rental restaurant; and
providing, by the central server, sales information of the shared restaurant of the profile manager to a terminal of a favorable user who clicked the like button in a profile channel operated by the profile manager who has signed the contract to rent the short-term rental restaurant,
wherein the profile channel comprises:
a map display field displaying a map, wherein only the map is displayed on the map display field while no restaurant is operated by the profile manager, and sales information including a location of the restaurant operated by the profile manager and a business period are additionally displayed on the map display field while the restaurant is operated by the profile manager after completion of a contract to rent a short-term rental restaurant; and
a franchise button for applying for a franchise operated by the profile manager, wherein a user who clicks the franchise button obtains profile manager authority of the franchise when permitted and thus sales information is transmitted to an existing customer group when the user rents a shared restaurant.

2. The method of claim 1, further comprising providing retrieved information to a terminal of a user by searching for profile channels in which a restaurant is open at a search location and a visit date that are input by the user.

3. The method of claim 1, further comprising, when a location and a date are input by the user, providing retrieved information to a terminal of a user by searching profile and shared restaurant rental information for the shared restaurants near the input location and profile channels of the shared restaurants rented at the input date.
